(19) United States
(12) Patent Application Publication
(10) Pub. No.: US 2006/0176524 A1
(43) Pub. Date: Aug. 10, 2006

(54) Compact portable document digitizer and organizer with integral display

(75) Inventor: Candace Yvette Willrich, Grand Prairie, TX (US)

Correspondence Address: BAY AREA INTELLECTUAL PROPERTY GROUP, LLC, PO BOX 210459, SAN FRANCISCO, CA, 94121-0459, US

(73) Assignee: Willrich Scott Consulting Group, Inc., Redwood City, CA (US)

(21) Appl. No.: 11/346,743

(22) Filed: Feb. 2, 2006

Related U.S. Application Data
(60) Provisional application No. 60/651,044, filed on Feb. 8, 2005.

(51) Int. Cl. H04N 1/04

(52) U.S. Cl. 358/474

(57) ABSTRACT

A hand-held image digitizer is provided, which comprises a chassis having first and second components, and a scanner disposed within the chassis, the scanner being adapted to digitize the image of a surface of a document placed within a scanning region inside of said chassis. The chassis is movable from a first configuration in which the scanning region is sealed off, to a second configuration in which the scanning region is open to receive a document.

### CROSS-REFERENCE TO RELATED APPLICATIONS

The present Utility patent application claims priority benefit of the U.S. provisional application for patent number U.S. 60/651,044 and entitled “Compact Portable Document Digitizer and Organizer with Integral Display” filed on Feb. 8, 2005 under 35 U.S.C. 119(e). The contents of this related provisional application are incorporated herein by reference.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to imaging devices. More particularly, the invention relates to portable image digitizers.

### BACKGROUND OF THE INVENTION

Image digitizers have become increasingly popular as a means for reducing paper clutter. Such devices allow hard documents to be digitized for retrieval, viewing or printing at a later time. For example, without limitation, commercially available desktop scanners allow photographs or business documents to be digitally scanned for storage in a suitable medium, such as, but not limited to, a compact disk, DVD or hard drive.

More recently, image digitizers have been developed that are more portable and are equipped with additional functionalities. One example of such a device is shown in FIG. 1. The device shown therein is a hand-held multifunctional peripheral (MFP) device that is fashioned in the form of a personal digital assistant (PDA). This device comprises an operation panel, a control processing unit, and a scanning apparatus.

The scanning apparatus is integrated into the PDA. The scanning apparatus is situated inside the base, and a scanning channel, which is designed as the passage for the to be scanned document, passes through the base from the lateral side to the opposite side. To proceed with the scan, the document to be scanned is inserted into and slid through the scanning channel. This document may be, for example without limitation, a business card.

While the aforementioned device may be suitable for its intended purpose, it has some significant infirmities. In particular, the open scanning channel of this device provides an opening for the introduction of dirt or debris into the interior of the device, especially if the device is placed in a pocket or other similar environments such as, but not limited to, a purse or a briefcase. These contaminants can adversely affect the quality of the scan, and over time can lead to failure of the device.

Moreover, while PDAs and image digitizers of reduced size are currently available in the marketplace, these devices are still somewhat bulky, and are thus not convenient for the mobile business user. For example, without limitation, these devices are typically too large to fit inside of a user's pocket.

There is thus a need in the art for a hand-held image digitizer, which does not suffer from the aforementioned infirmity. In particular, there is a need in the art for a hand-held image digitizer in which the scanning channel is protected from contaminants while the device is not being used to scan a document. There is further a need in the art for such a device, which is suitable for use in scanning business cards and other small documents at conventions, seminars, and other such occasions. There is also a need in the art for an image digitizer or PDA that is small enough to carry on the user, for example, without limitation, in the user's pocket, purse or briefcase. These and other needs are met by the devices and methodologies disclosed herein and hereinafter described.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a perspective view of an exemplary existing portable digitizer;

FIG. 2 through FIG. 5 illustrate an exemplary pop-up digitizer, in accordance with an embodiment of the present invention.

FIG. 2 shows a perspective view of the digitizer in the open position.

FIG. 3 shows a perspective view of the digitizer in the closed position.

FIG. 4 shows a cross sectional view of the digitizer taken along LINE A-A of FIG. 2, and

FIG. 5 shows a top view of the digitizer;

FIG. 6 illustrates the interior of an exemplary portable digitizer, in accordance with an embodiment of the present invention;

FIG. 7 shows a perspective view of an exemplary pop-up digitizer with a long-side sheet feeder, in accordance with an embodiment of the present invention;

FIG. 8 shows a perspective view an exemplary clamshell digitizer, in accordance with an embodiment of the present invention;

FIG. 9 shows a cross-sectional view of the lower portion of an exemplary clamshell digitizer, shown in FIG. 8, taken along the LINE 9-9, in accordance with an embodiment of the present invention,

FIG. 10 illustrates an exemplary clamshell digitizer with imaging on both sides of the clamshell, in accordance with an embodiment of the present invention;

FIG. 11 illustrates exemplary digitizers with multiple displays, in accordance with embodiments of the present invention,

FIG. 12 illustrates an exemplary digital Rolodex, in accordance with an embodiment of the present invention;

FIG. 13 and FIG. 14 illustrate exemplary bowl scanning devices, in accordance with embodiments of the present invention;

FIG. 15 and FIG. 16 illustrate exemplary business card storage boxes, in accordance with an embodiment of the present invention.

FIG. 16 illustrates an exemplary business card storage box that is equipped with an automatic alphabetizer, in accordance with an embodiment of the present invention;

FIG. 17 illustrates an exemplary digitizer, in accordance with an alternative embodiment of the present invention, wherein the scanner is located at the bottom of the device where computing resources is typically located;

FIG. 18 illustrates an exemplary digitizer device, in accordance with another embodiment of the present invention; and

FIG. 19 illustrates a typical computer system that, when appropriately configured or designed, can serve as a computer system in which the invention may be embodied.

Unless otherwise indicated illustrations in the figures are not necessarily scale.

### SUMMARY OF THE INVENTION

To achieve the forgoing and other objects and in accordance with the purpose of the invention, a variety of techniques for a compact portable document digitizer and organizer with integral display are described.

In one aspect, a hand-held image digitizer is provided herein which comprises a chassis having first and second components, and a scanner disposed within the chassis, the scanner being adapted to digitize the image of a surface of a document placed within a scanning region inside of the chassis. The chassis is movable from a first configuration in which the scanning region is sealed off, to a second configuration in which the scanning region is open to receive a document. Preferably, the first component of the chassis is movable with respect to the second component of the chassis, and is equipped with an aperture that is in open communication with the scanning region when the image digitizer is in the second configuration, but is in closed communication with the scanning region when the image digitizer is in the first configuration. Most preferably, the first component is spring-activated, and pops up after pressure is applied to its surface.

In another aspect, a hand-held image digitizer is provided which comprises a housing comprised of a base component and a pop-up component with an aperture therein; a scanning region inside of said housing, and a scanner disposed within said housing adjacent to said scanning region, said scanner being adapted to digitize the image of a surface of a document placed within the scanning region. The pop-up component is movable from a first position in which said scanning region is sealed off from the exterior of said housing, to a second position in which said scanning region is open to receive a document via said aperture. Preferably, the image digitizer further comprises a light source disposed near said scanning region and adapted to provide light for scanning, and a photoelectronic imaging device disposed adjacent to said scanning region and being adapted to capture the image of a surface of a document disposed in said scanning region. The pop-up component is preferably movable from said first position to said second position by the application of finger pressure to said second component.

In still another aspect, a personal digital assistant (PDA) is provided herein which comprises a housing having a base and a cover hingedly connected to said base; a scanning region defined on a surface of said base; and a scanner disposed within said base adjacent to said scanning region, said scanner being adapted to digitize the image of a surface of a document placed on the scanning region. The PDA is preferably a hand-held device which comprises a control panel adapted to input user commands, and a processing unit in electronic communication with said control panel, said processing unit being adapted to receive and process user input commands from the control panel.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternatives embodiments do not necessarily imply that the two are mutually exclusive.

The present invention will now be described in detail with reference to embodiments thereof as illustrated in the accompanying drawings.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

In one embodiment, a hand-held image digitizer is provided herein which comprises a housing having a base component and a pop-up component with an aperture therein, a scanning region inside of said housing; and a scanner disposed within said housing near said scanning region, said scanner being adapted to digitize the image of a surface of a document placed within the scanning region. In this embodiment, the pop-up component is movable, for example, without limitation, through the application of finger pressure, from a first position in which said scanning region is sealed off from the exterior of said housing, to a second position in which said scanning region is open to receive a document via said aperture. In alternate embodiments, the pop-up portion may also include scanner and sheet feeder functionalities. Because the scanning region can be readily sealed off when the image digitizer is not in use in the present embodiment, contamination of the scanning channel is minimized. Consequently, the image digitizer is well adapted to being carried on the user, for example without limitation, in a pocket, purse, or briefcase.

In another embodiment, a personal digital assistant (PDA) is provided herein which comprises a housing having a base and a cover hingedly connected to said base, a scanning region defined on a surface of said base, and a scanner disposed within said base near said scanning region, said scanner being adapted to digitize the image of a surface of a document placed on the scanning region. In this embodiment, the PDA is preferably a hand-held device which comprises a control panel adapted to input user commands, and a processing unit in electronic communication with said control panel, said processing unit being adapted to receive and process user input commands from the control panel. Since it is an aspect of this embodiment that documents can be scanned simply by placing them on the scanning region that is typically a flat glass surface and closing the cover, the device does not require a document feeder or other such mechanism, which is a common cause of failure in other devices of this type. Moreover, the scanner in this embodiment can be sealed within the base, where it is shielded from external contaminants. This approach can also be used to protect scanning elements in other devices, such as copiers, printers, shredders, and various hand-held devices. Also, a scanning device, according to the present embodiment, can accommodate odd-sized cards or documents, and can also accommodate documents printed on non-rigid substrates, such as, but not limited to, onion paper. It is contemplated that in many practical applications, the laptop computer, or a product similarly designed, can be used simultaneously as a scanning device using the display, by placing a document on the surface of the display, and either, pressing a button to scan, or by closing the device to initiate scanning; thereby enabling larger documents to be scanned using single or dual displays.

An aspect of the present invention is to provide a device that may be utilized to perform functions such as, but not limited to, digitizing, analyzing, storing, sorting, organizing, retrieving, communicating, and displaying images of small printed documents, such as, but not limited to, business cards, driver's licenses, social security cards, health care ID cards, and credit cards. In the preferred embodiments, these devices are small enough to fit into a person's pocket, for example, without limitation, the device may have physical dimensions of no more than about 4 inches by about 6 inches by about 1 inch, but alternate embodiments may be much larger if desired. The digitized and analyzed data can be automatically communicated to a device such as, but not limited to, a personal computer (PC), personal digital assistant (PDA), telephone, cell phone, television, monitor, or other electronic devices with other storage using an appropriate interface, such as, but not limited to, USB, Ethernet, Serial, Wireless, CD-ROM, Memory Stick, or other computer or digital interface.

Several variations of these devices can be made in accordance with the teachings herein. For purposes of illustration, these devices will be described herein with reference to the following two embodiments, it being understood that the devices and methodologies described herein are not necessarily limited to these embodiments. The first of these embodiments is a popup digitizer with a storage cassette, and the second of these embodiments is a clamshell digitizer. Each of these variations is described in greater detail below.

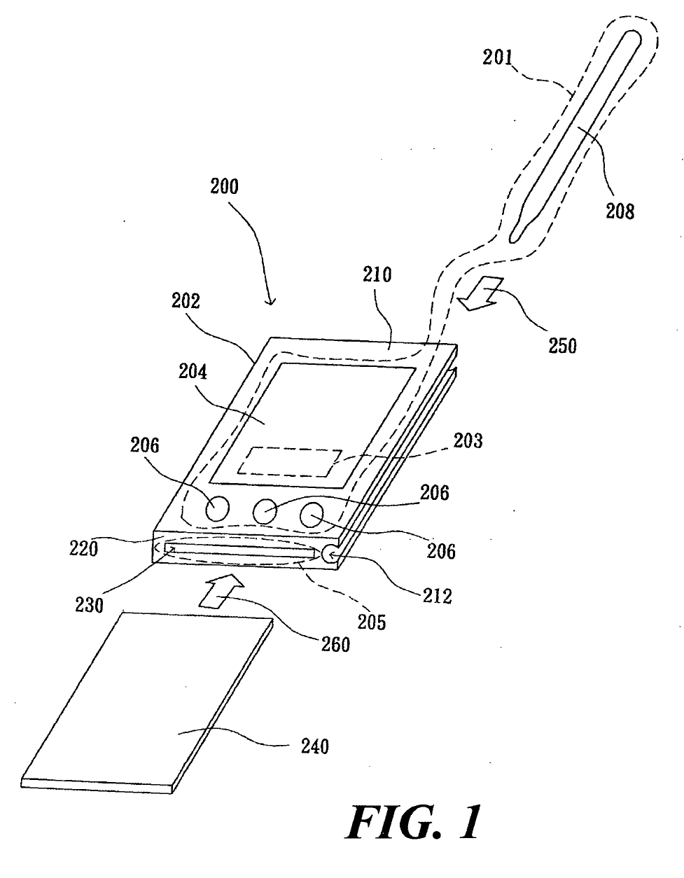

FIG. 1 illustrates a perspective view of an exemplary existing portable digitizer. A device 200 is a hand-held multifunctional peripheral (MFP) device that is fashioned in the form of a PDA. Device 200 includes an operation panel 201, a control-processing unit 203, and a scanning apparatus 205. Operation panel 201 and scanning apparatus 205 are electrically connected to control processing unit 203. Operation panel 201 permits the user to input the data and scanning instructions. Control processing unit 203 is designed to perform logic operations or data processing, and to receive scanning orders from scanning apparatus 205. For example, without limitation, after the user inputs the data or the scanning order to device 200 via operation panel 201, the logic operation is processed by control processing unit 203, and control-processing unit 203 also controls the operation of scanning apparatus 205. Accordingly, device 200 is a two-in-one device and possesses the functions of a PDA and a scanner.

Device 200 is equipped with a base 202 and operation panel 201 that includes a display 204, three control buttons 206, and a stylus 208. Display 204, which may be any conventional and suitable display; by way of example, and not limitation, a touch screen integrated with a Liquid Crystal Display (LCD), with control buttons 206 mounted on a top surface 210 of base 202 for operation. As referred to herein, “touch” with respect to a screen or display comprises any means associated with the screen or display that is responsive to physical contact as an input; for example, without limitation, touch by a finger, stylus or pen for writing on a display, etc.

Removable stylus 208 is placed in a stylus holder 212 in base 202 and can be removed from stylus holder 212, or inserted into stylus holder 212 along the direction of an arrow 250 as needed. To process the logic and/or scanning operations, the user can input data and/or scanning orders to device 200 by lightly touching display 204 with stylus 208. Control processing unit 203 is situated inside base 202 and is electronically connected to display 204 for receiving and processing the data and the scanning order transmitted from display 204.

Scanning apparatus 205 is integrated into device 200. Scanning apparatus 205 is situated inside base 202, and a scanning channel 230, which is designed as the passage for a to be scanned document 240, passes through base 202 from a lateral side 220 to an opposite side. To proceed with the scan, document 240, which is to be scanned, is inserted into scanning channel 230 along the direction of an arrow 260. This document may be, for example without limitation, a business card, credit card, drivers license, ID card, etc.

While device 200 may be suitable for its intended purpose, it has some significant infirmities. In particular, the openness of scanning channel 230 of device 200 provides an opening for the introduction of dirt or debris into the interior of device 200, especially if device 200 is placed in a pocket or other such environments such as, for example, without limitation, a purse or a briefcase. These, contaminants can adversely affect the quality of the scan, and over time can lead to failure of device 200.

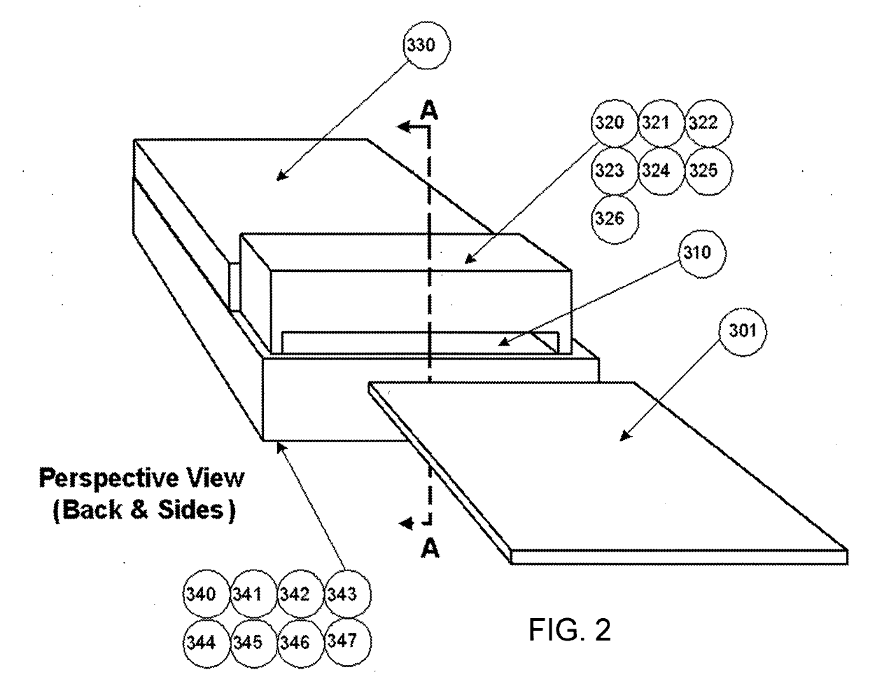

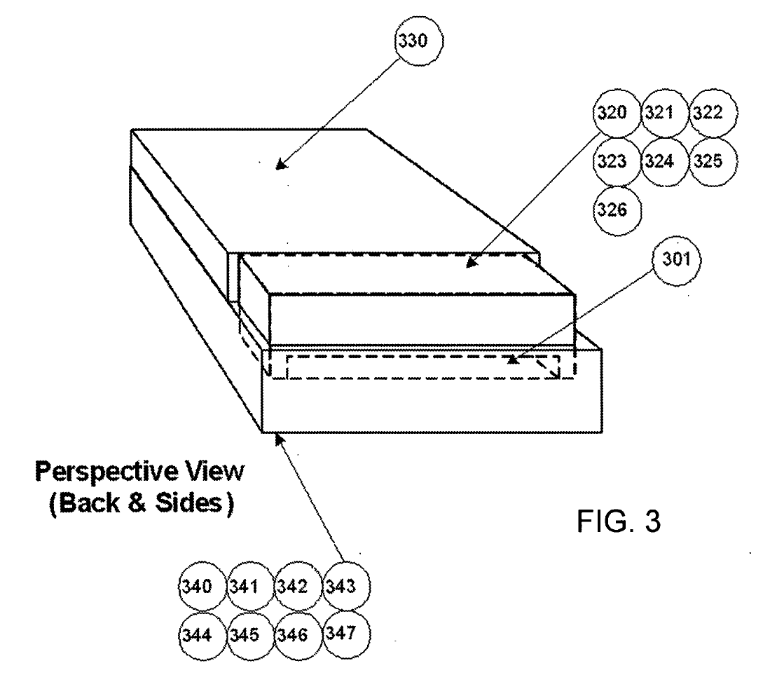

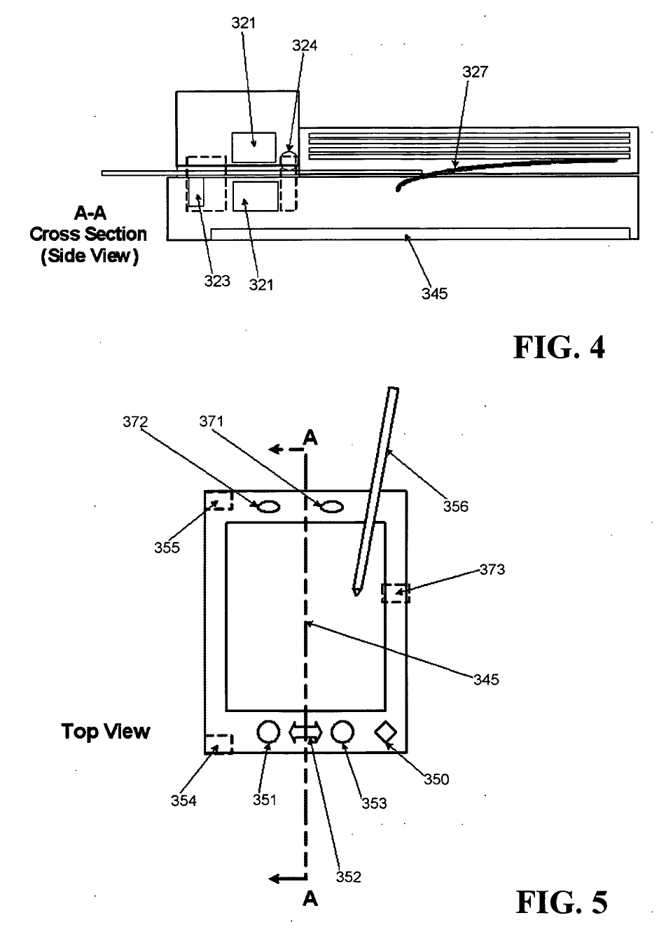

FIG. 2 through FIG. 5 illustrate an exemplary pop-up digitizer, in accordance with an embodiment of the present invention. FIG. 2 shows a perspective view of the digitizer in the open position. FIG. 3 shows a perspective view of the digitizer in the closed position. FIG. 4 shows a cross sectional view of the digitizer taken along line A-A of FIG. 2, and FIG. 5 shows a top view of the digitizer.

The present embodiment makes a digital image of small documents such as, but not limited to, business cards (typically 2 inches by 3.5 inches), drivers licenses (2.4 inches by 3.6 inches), social security cards, health card ID cards, credit cards, etc. Optionally, the present embodiment can also physically store documents, for example without limitation five or more, depending on thickness, in a document storage cassette 330.

The present embodiment is equipped with a document feeder slot 310, through which a small document 301 or card is inserted. The digitizer further includes a scanner and feeder 320 that contains a contact linear scanner imager 321. Such imagers are commercially available from a number of vendors and can be used to scan the document in color or in black and white to produce the scanned electronic image. In some embodiments there may also be a photoelectric imaging device near the scanning region that can capture an image of the surface of document 301. Also, some embodiments may include a light source near the scanning region to provide light for scanning. Alternative embodiments may combine document storage cassette 330 and feeder 320 when in retracted position with a display that extends over the entire area, or can optionally open, to reveal a display.

In the present embodiment, scanner and feeder 320 can be extended or retracted to reveal or hide slot 310, respectively. In the preferred embodiment, scanner and feeder 320 is spring activated and is extended or retracted by the application of finger pressure by the user. In the unused state, scanner and feeder 320 is retracted and the device is more compact in the retracted position than in the extended position. Also when scanner and feeder 320 is in the retracted position, slot 310 is hidden when not in use, and this helps prevent dirt and other foreign matter from entering slot 310. In the preferred embodiment, slot 310 is revealed when scanner and feeder 320 is in the extended upward position as shown in FIG. 2. When scanner feeder 320 is in the retracted downward position, feeder slot 310 is hidden, as indicated in FIG. 3. In alternate embodiments scanner feeder 320 may be stationary, or feeder slot 310 may be built into the main body of the device.

In the present embodiment, scanner and feeder 320 comprises an automatic feeder mechanism 322 (hidden inside scanner and feeder 320) which detects document 301 using a physical or optical detector 323 (hidden inside scanner and feeder 320) and feeds document 301 through feeder slot 310 using a feeder drum 324 driven by an electric motor 325 (both hidden inside scanner and feeder 320) with or without speed-reducing gears 326 (hidden inside scanner and feeder 320) at a rate that is optimal for the scanning performed by scanner imager 321. Depending on the type of scanner is used or the needs of the particular application, some scanner embodiments of the present invention do not require electric motor 325 and speed-reducing gears 326 as will be readily appreciated by those skilled in the art. Those skilled in the art will also readily recognize, in light of the present teachings, how to best implement the foregoing hidden components (e.g., without limitation an illuminator, a window, gears, and etc.) in accordance with known techniques.

Cassette 330 can physically store documents, such as but not limited to business cards that have been scanned. Cassette 330 is an optional feature of the digitizer. A spring or other guide mechanism 327 pushes the previously scanned cards out of the way once they have been scanned.

A main body 340 of the device, comprises a controller circuit with microprocessor 341, permanent or removable digital storage 342 such as, but not limited to, RAM, Flash RAM, Writeable CD-ROM, Writeable DVD, magnetic strip, Hard Drive, Floppy Disk, USB Drive, or other proprietary digital storage or analog storage that can be used as digital storage, an external computer interface 343, an interface 344 between controller and scanner, a display 345 that is optionally a touch-screen, an interface 346 between display and microprocessor, and battery 347 or portable power supply. Microprocessor 341 can execute computer programs stored in the memory. For example, without limitation, microprocessor 341 can store scanned images in memory and then perform optical character recognition on those images to read the writing on document 301 or collect images on document 301. These images and text can then be inserted into a database, such as, but not limited to, a contact database that is stored either in the memory of the device or communicated to another device for collection, interpretation, or storage. Display 345 and battery 347 ensure that the user can view the digitized documents, so that the device can be used in a portable manner without requiring that the device be connected directly or indirectly, for example, without limitation, as through a laptop, to an external power supply. In an alternate embodiment, the device has no display.

In the present embodiment, display 345 may be a pure display or a touch-screen. A power on/off button 350, and optional navigation and selection buttons 351, 352, and 353 are shown in FIG. 5. Navigation buttons 351, 352, and 353 can be used to communicate with the device, for example without limitation, by controlling scans or browsing through images. In alternate embodiments, the device may have two or more displays. In some embodiments, the device may be constructed with a tri-fold configuration such that the device and displays may be arranged in a foldable manner with three displays.

Power on/off button 350 is a typical implementation, although alternate implementations may include an “automatic on” function that activates the device when a document is inserted or a cover is opened. An automatic power off after a period of non-use is an alternate or optional additional implementation of power on/off An optional and preferred computer interface port 354 and associated internal circuitry, such as, but not limited to, a USB, Serial, Parallel or proprietary interface, is also shown in FIG. 5, although the exact location is a matter of user preference and may be related to the design of the internal circuitry. An optional wireless antenna 355 and associated internal circuitry may also be present to implement wireless communication such as, but not limited to, Bluetooth or other protocols. An optional stylus 356 or pen device may be used for the optional touch-screen.

The present embodiment also comprises a microphone 373 and speakers 371 and 372. Microphone 373 can be used to add audio annotation to the images, and speakers 371 and 372 can play back audio annotations to check or review them. A jack for a headset for audio-playback of the information or annotations can also be optionally included. In some embodiments, speakers 371 and 372 and microphone 373 may be configured to operate across a single computing interface. A camera may optionally be included in some embodiments.

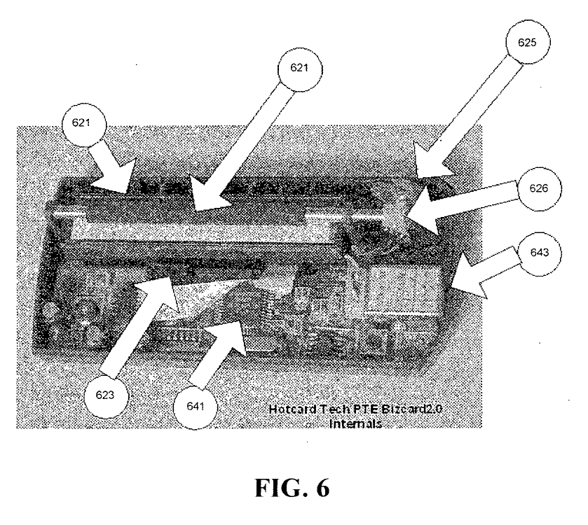

FIG. 6 illustrates the interior of an exemplary portable digitizer, in accordance with an embodiment of the present invention. The device depicted is a fixed-slot, sheet-fed scanner. The present embodiment comprises many of the same elements as the embodiment shown in FIG. 2 through FIG. 5, including, but not limited to, a contact linear scanner imager 621, a document detector 623 for the automatic feeder, an automatic feeder drum 624, an electric motor 625, a speed-reducing gear 626, a scanner controller 641 and an external computer interface 643.

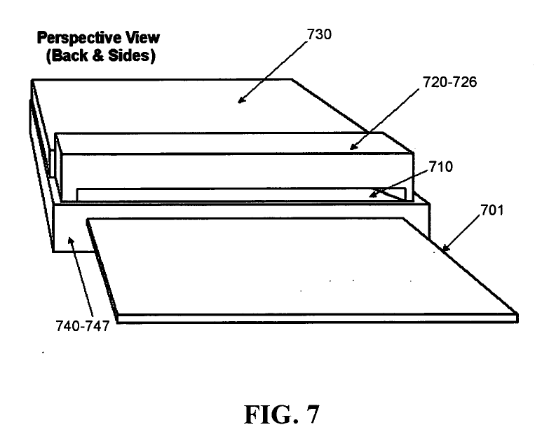

FIG. 7 shows a perspective view of an exemplary pop-up digitizer with a long-side sheet feeder, in accordance with an embodiment of the present invention. The present embodiment comprises a feeder slot 710 where a document 701 is inserted to be scanned, a cassette 730 to hold previously scanned documents, a scanner and feeder 720, an imager 721, an automatic feeder mechanism 722, a physical or optical detector 723, a feeder drum 724, and an electric motor 725. A main body 740 of the digitizer also comprises a controller circuit with microprocessor 741, permanent or removable digital storage 742, an external computer interface 743, a controller scanner interface 744 a display 745 that is optionally a touch screen, an interface 746 between display 745 and microprocessor 741, and a battery 747 or other portable power supply. The present embodiment is similar to the embodiment illustrated in FIG. 2 through FIG. 5. The difference being that feeder slot 710 for, in the present embodiment, is positioned on the long side of the device instead of the short side of the device as in the embodiment shown in FIG. 2 through FIG. 5. In the present embodiment, the pop-up component may be very small and thin or larger, for example, without limitation, the size of a business card.

It will be appreciated that the pop-up design disclosed herein may also be extended to other types of devices. For example, without limitation, a variety of devices, such as, but not limited to, laptop computers, keyboards, and displays, may be provided with pop-up modules adapted to read, scan and/or process items such as, but not limited to credit cards; business cards, ID cards, etc. In some embodiments these modules may be designed to retract back into the body or case of the device they are incorporated into when they are not in use.

Another embodiment of the devices disclosed herein is the clamshell configuration. Instead of inserting the document to be scanned into a slot-feeder scanner, the document, such as, but not limited to, a business card, driver's license, credit card, etc., is placed on a small flatbed scanner. During the scanning operation, the document is held in place with a lid that can pivot on or is connected by a hinge to the side or top of the scanner. When the device is not being used for scanning, the lid is normally left in the closed position to protect the scan bed.

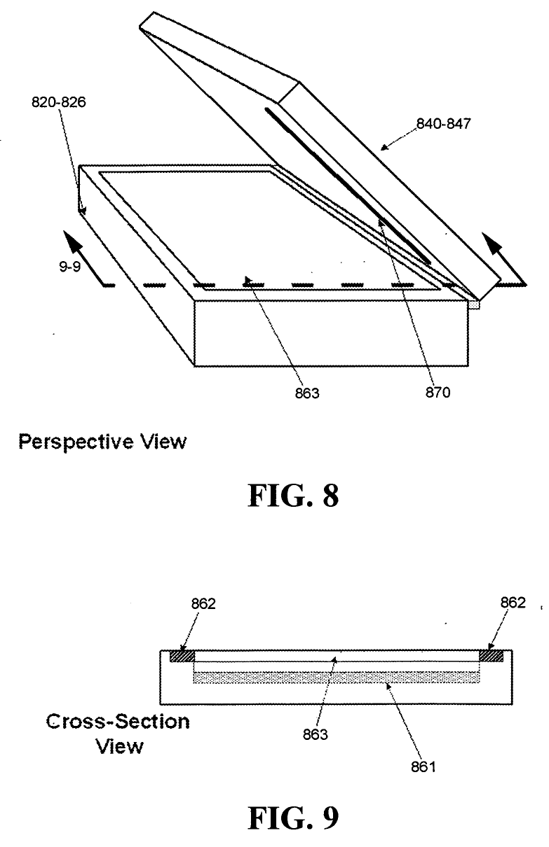

FIG. 8 shows a perspective view an exemplary clamshell digitizer, in accordance with an embodiment of the present invention. The present embodiment comprises a scanner bed 820 that is part of a base fixture 840. The present embodiment also comprises an imager 821, and a physical or optical detector 823. Imager 821 may be a variety of scanner types such as, but not limited to, a camera lens or a linear scanner. The document to be scanned is placed facedown on scanner bed 820, and detector 823 senses the presence of a document. Base portion 840 of the present embodiment comprises a controller circuit with microprocessor 841, a memory 842, an external computer interface 843, an interface between controller and scanner 844, and a battery 847 or other portable power supply. The top housing of the present embodiment comprises a display 845 that is optionally a touch-screen. An interface 846 connects display 845 and microprocessor 841. In some embodiments display 845 may be on the inside of the device and the user accesses it by opening the top housing. In the present embodiment when the top housing is closed, the unit functions and looks like a normal PDA, similar to the device shown in FIG. 5, but has the additional feature of being able to swivel open to scan documents.

When the top housing is closed, the user can watch the scan progress as display 845 fills up with the image of the card below it. Then, if necessary, adjustments to the scanned image, such as, but not limited to, positioning, sizing, cropping, etc., can be made using the optional stylus or the PDA controls before committing the scan to memory 842. Finally, a pocket 870 provides a small storage area, or compartment, where documents that have been scanned can be stored temporarily. In some embodiments, this storage area may be provided with a door to permit easy removal of items stored therein. In alternate embodiments, the storage compartment may be a slot in the housing, a hard plastic box, etc. By way of example, and not limitation, alternate embodiments may be made to be larger than the size of a card, e.g., twice the length, wherein the remaining space beneath the display is available as a storage compartment, thereby, for example, providing a mobile device that has a bigger display, elegant casing, and still plenty or room for the printed cards. By way of example, and not limitation, in embodiments where the present device opens and closes like a book, one side of the opened device may be configured to comprise a compartment, or optionally, comprise leather holders to hold the physical products. The compartment can be pulled out or released from the unit in a multiplicity of obvious ways, for example, similar to that of a tray. In yet other embodiments, thin plastic folders or holders may be configured inside the housing so that printed cards can be inserted into a traditional holder. Yet other alternative storage compartments include, but are not limited to: a tray, a pull-out tray, a storage box, a storage box with a lid, a storage box with dividers, a storage box with a lock, or if device is larger, then compartment could be a storage area behind the entire display.

FIG. 9 shows a cross-sectional view of the lower portion of an exemplary clamshell digitizer, shown in FIG. 8, taken along the LINE 9-9, in accordance with an embodiment of the present invention. In this cross-section, an illuminator(s) 862, a window 863, and an imager 861 are shown. Window 863 may be purely transparent or act as a lens. Imager 861 may or may not have a lens on top of it to focus the image. Imager 861 may either be a monolithic CCD, CMOS imager, photodiode array, or a contact linear imager that is moved across the length of the document while imaging one or more lines at each position. Some embodiments may have the ability to crop the image. In some embodiments there may also be a photoelectric imaging device near the scanning region that can capture an image of the surface of the document in the scanning region. Also, some embodiments may have a light source adjacent to the scanning region to provide light for scanning. In alternate embodiments a feeder slot may be positioned on the inside of the device instead of or in addition to the flatbed scanner. In other embodiments there may be a pop-up scanner similar to the scanner shown in FIG. 2 through FIG. 5 that pops up when the device is opened.

In the closed position, display 845 is visible and accessible. The image is illuminated by any of a variety of means, such as, but not limited to, LED's, fluorescent lamps, Xenon lamps, etc. Opening the device by means of hinges reveals scanner windows 863 where documents are to be placed.

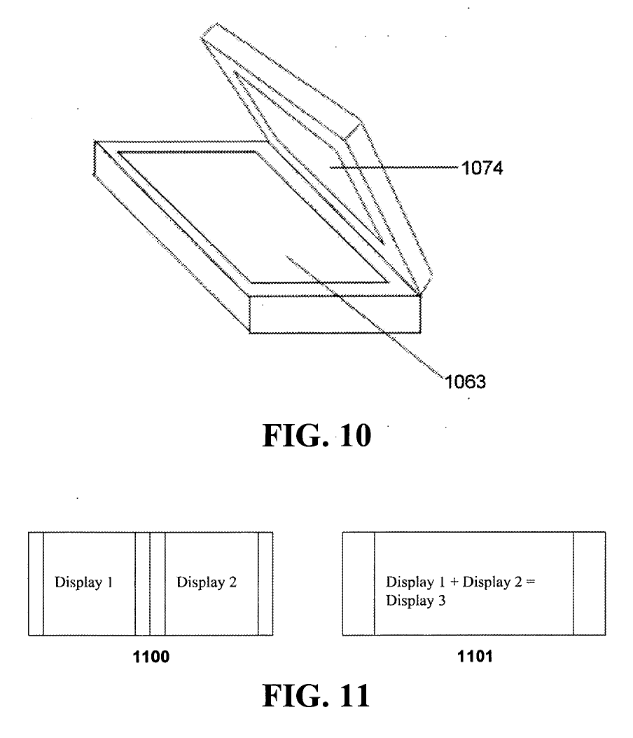

There are alternate embodiments of the side-opening clamshell design shown in FIG. 8. One alternate embodiment is shown in FIG. 10. FIG. 10 illustrates an exemplary clamshell digitizer with imaging on both sides of the clamshell, in accordance with an embodiment of the present invention. This embodiment allows both sides of a document to be imaged simultaneously or one side of two separate documents to be imaged simultaneously because the document or documents are placed between a lower scanning area 1063 and an upper scanning area 1074. Such dual imager configurations preferably have two sets of optical components such as, but not limited to, those shown in FIG. 9. In addition to the optical components on which the document is placed to be scanned, another imager with its optical components is put in place of pocket 870, shown in FIG. 8.

In some embodiments, the imager and optical components are disposed only on the top housing of the device, and the documents are placed in lieu of window 863 depicted in FIG. 9. One advantage of this variation is that the documents can be stacked and stored in the bottom housing. A spring or pneumatically loaded bottom, underneath the stack of documents, can ensure that the documents are pressed against the window on the opposing side when the clamshell design is closed with the documents in place.

A number of implementations are possible for the devices and methodologies disclosed herein. For example, without limitation, instead of being a small, standalone device, the scanner may be integrated into the case of a device such as, but not limited to, a laptop, computer display, keyboard, or daily planner. In such implementations, the user inserts the document into a slot or lays the document onto an imaging surface that is part of the scanning device, and the document is digitized.

In some embodiments, the devices described herein can be optionally equipped with a date and time function as well as a GPS antenna or other locator functions such as, but not limited to, RFID functions, or elements which allow the device, or some of its components, Such as, but not limited to, the hard drive, motherboard or display, to be disabled remotely if it is determined that the device is missing or has been stolen or misappropriated; this functionality may be implemented in some embodiments through the use of a centralized control center similar to the type used in a cellular network and can be adapted to automatically annotate the scanned documents with information about when and where they were scanned. This can be useful, for example, without limitation, to assist in locating physical document files to which the scanned images correspond. When combined with a daily planner calendar program, the device can be used to automatically associate an event in the planner program with the information being scanned. For example, without limitation, if the calendar had an event and location for a trade show, the device can be adapted to recognize this and annotate that information to an image associated with a business card that is being scanned at that trade shown. In some embodiments equipped with locator functions, the device or other mobile devices may emit a signal that enables the device to be located and found in many practical situations. In some alternate embodiments, the present device may be configured with an integrated circuit or chip installed specifically for location and signal technology designed according to a multiplicity of techniques known to those skilled in the art. In yet other alternate embodiments, a PCMCIA-like device, an internal adapter, or an external adapter can be designed to provide both location and signal technology. This embodiment may be self-operating; that is, operates without the need for computing power.

In some embodiments, the device may take the form of a watch, bracelet or other wearable item that is equipped with GPS functionality. Embodiments of the device may be suitable configured to locate missing persons or items when the person or item has a secondary device equipped with GPS functionality. This secondary device can be, for example, without limitation, a watch, bracelet, necklace, a keychain, a RFID tag (computers), or any other wearable items. The device is able to locate the person or item very quickly with usable location details. Authorities can be alerted through the use of software.

The embodiments described herein may also be adapted to interpret text, graphics, and encoded information on the documents being scanned. In addition, electronic information associated with the document, such as, but not limited to, a bar code, magnetic stripe, or RFID component, can be automatically sensed by the device and the information interpreted and presented to the user as well as annotated and included in the files or database for the digitized document.

Another embodiment may also be equipped with a multiple-document feeder so that a stack of documents can be scanned in rapid succession with little or no intervention from the user. In addition, the digitizer can be used to interpret the information on the documents and then communicate that information back to the multiple-document loader so that it can physically organize or sort the documents in a desired way. For example, without limitation, the scanner can be adapted to perform optical character recognition on the documents, after which the multiple-document loader can sort them according to a key name on the documents for example, without limitation, alphabetizing business cards or other documents. The multiple-document feeder may optionally include a storage compartment It should be noted that a multi-page scanner, copier, and printer technique refers to multiple pages that are scanned simultaneously, copied simultaneously, or printed simultaneously. This is preferably achieved by way of multiple sets of technologies or some combination thereof These scans may be automatic or manually. These multi-page products can execute against one job or multiple jobs.

The embodiments disclosed herein can digitize images in black and white or color, and can provide any number of digital formats, such as, but not limited to, direct bitmaps, vector files, or compressed image files. The digitization may be for one side or both sides of the documents, depending on the requirements of the document digitizer. The imager on some embodiments may be as simple as a camera lens.

The embodiments described herein may utilize several different card insertion methods, which may be used in conjunction with the scanning or imaging process. The following are some non-limiting examples.

In some embodiments the device may be provided with a detector that detects the presence of the card in the scanning area or at the opening thereof. The device then operates to draw the card into the scanning area (if necessary), scan the card, and eject the card (if necessary). In some embodiments, the device may also be configured to check for or detect errors on the card or in the scanned image and correct them.

In some embodiments the device may be provided with a first slot that the card to be scanned slides into, and a second slot, which may be located on the same surface or on a different surface of the device, from which the card is ejected. For example, without limitation, the first slot may be located at the top of the device and the second slot may be located at the bottom of the device, or the first slot may be located at one end of the device and the second slot may be located at another end of the device. In some embodiments the scanner region may open at an angle or slant for the insertion of the document.

In other embodiments the document may be swiped over the imaging area. The document may be placed over or swiped over an imaging area using any of the device styles described in other embodiments. The image of the document may be taken by an automatic sensor or by pressing a button on the device to initiate an image or to snap an image using a camera lens.

In some embodiments the device may be equipped with a display area that has an imaging area disposed within it. This imaging area may be separate from the display area, or may function as a dual display/imaging area. The card is then placed on the display area, and scanning is initiated.

In some embodiments the device may be equipped with an open inner glass case. The card is placed on the imaging area or is inserted into a slot, and the case is closed. Scanning, is then initiated. In some embodiments, the inner case may have a glass-like cover that lifts so that a card can be inserted into the case.

In some embodiments the device may be slid over a document to progressively digitize text or images.

In embodiments featuring a pop-up component, the device may be provided with scanning technology that operates off of the pop-up component so that scanning may be performed without the need to insert a card or other document into the device.

In some embodiments the device may be provided with a scanning array, which may be, for example, without limitation, a vertical or horizontal line of sensors, disposed in the middle of the device. The scanning array may be controlled by software, which is adapted to sense the orientation or size of a document being scanned. Preferably, the scanning array is activated by placing the device into scanning mode. In some embodiments, scanning mode may be activated by swiping a document over the scanning area.

In some embodiments the device may be provided with an accessory, such as, but not limited to, a clear card, which may be used to test, calibrate or clean the scanner. This accessory may have text or images on it, which may be designed for testing purposes.

Various power supplies may be used to drive the device. For example, without limitation, the device may be solar powered, powered through an interface such as, but not limited to, USB, powered with a disposable or replaceable battery, powered by a fuel cell, and/or powered by a rechargeable battery. The device may also be equipped with one or more batteries or battery packs that serves to recharge another battery or battery pack.

Some embodiments may comprise an integrated circuit designed to produce the light needed for the imaging of documents and to accomplish the imaging itself This circuit can be very small, for example, without limitation, a very small chip, or much larger, for example, without limitation, the size of a business card. Variations of the circuit are possible. This integrated circuit reduces the amount of technology needed to provide scanning for small documents and allows the device to be small. In some embodiments, the circuits may be creatively architected, for example, without limitation, they may be back to back to make the circuit thin and to add extra power. The integrated circuit's components may comprise a camera lens that snaps the image of the area where the business card sits through any number of methods. Technology similar to optical disc readers (the diode that moves across the length of the optical disc) may also be used in some application. This item is preferably small enough so that it can quickly read a business card.

Various operating platforms may be used in the embodiments described herein. These include, but are not limited to, palm os, java os, pocket pc os, xp, or other such platforms. These platforms may have one or more of the following features. Information scanned from a business card may be displayed in a business card format, either in color or in black and white. The device may have the ability to convert or segregate digital images into parts, and may further have the ability to manage these parts on the device. The device may be adapted to convert loaded text to a business card-like appearance, without logos or colors. Data may be time/date stamped as it is scanned.

In some embodiments the device may be configured to display contact notes. These contact notes may be entered directly into the device, or may be entered from a desktop computer and communicated to the device. The device may be equipped with a stylus or writing device to permit notes to be entered directly into the device. In addition to having the ability to input information into the device or to modify information recorded on the device, the stylus or writing device may have full or partial writing capability which allows it to be used as a pen on paper or other common substrates. In these embodiments, the stylus or writing device may be provided with a functionality that allows the notes made on the substrate to be recorded by the device. The stylus or writing device may be adapted to write in one or more colors, both on the substrate and within the device or as recorded by the device, and may be adapted to write with varying line widths, for example, without limitation, it could be set to mimic a pen or a marker. The stylus or writing device may also have full or partial scanning capabilities. In one embodiment, for example, without limitation, the stylus or writing device may be equipped with a button that can be pressed to open a slot through which a document can be fed, and the interior of the stylus may be equipped with a scanning array to scan a document fed through the slot.

In some embodiments the software on the device allows notes to be added anywhere and in any application including, but not limited to, notepad, word processors, spreadsheets, and email. These notes can be added by different methods including, but not limited to, a pen by writing, a stylus, or by using a keyboard. Notes can also be added by selecting items from a selection list, stored in a database. These notes can be stored on the device for example, without limitation, as in a notes database or sent out via email or other application. In some embodiments a writing pad component is provided for the user to write notes on that can be connected or disconnected from the scanner. In this embodiment, the circuitry for the writing pad may be located in the scanner or in the writing pad.

Other features that may be included in the operating platform of the different embodiments are as follows, without limitation. The device may be password protected. The device may be equipped with suitable audio hardware and software to allow users to record or listen to audio notes. The device may be configured to provide an indicator so that the user knows that text and/or audio notes are available. Embodiments may also be configured to enable the user to send the audio note(s), on a contact or for any other reason, to a secretary from the device, whereby, for example, the secretary receives the note, types up a hardcopy of the note, and makes it available for user or for others. Those skilled in the art will readily implement this software in a multiplicity of suitable ways depending upon the needs of the particular application. In some embodiments, the device may be provided with software to allow the user to categorize business cards. This software may come with a list of category options and may be configured to allow the user to add additional categories via a desktop computer or via a keyboard display. This software may also allow documents to be color coded as they are scanned into the device for categorization.

In some embodiments the device may be equipped with suitable anti-virus or security software. The device may be equipped with security hardware such as, but not limited to, a latch, a key, a door, a lock, or an activation mechanism. For example, without limitation, the device may be equipped with a latch similar to the type found on conventional laptop computers. In some embodiments, the latch may serve as a cover for the scanning region when the device is in a closed position. In other embodiments, the device may be equipped with a door to the scanning region that is configured so that, for example, without limitation, when a button on the device is pressed, the door to the scanning region opens, the door flattens, and a business card or other item to be scanned may be placed on the surface of the door. The door then moves into the scanning region so that scanning can commence. The door in this embodiment may also serve as a holding or positioning area for the item to be scanned prior to entry into the scanning region.

In other embodiments the device may be equipped with a case, which may be made out of various materials such as, but not limited to, leather, plastic, fabric, metal, granite, marble. The case may be stylized in various colors and designs. The device may be equipped with various media storage devices as are known to the art. These include, for example, without limitation, magnetic or optical disks, memory cards, etc. The media storage devices may be removable from the device. For example, without limitation, the media storage device may comprise one or more memory sticks that can be removably inserted into the device. The device may also be provided with one or more storage areas to store additional media storage devices.

In some embodiments the device may be provided with software that detects when a printed card is being scanned or is available for scanning, and this software may be configured to provide alerts to the user that a card is being scanned. The device may be provided with a suitable means for notifying the user that a card has been successfully scanned. Such means may include, without limitation, an audio signal such as, but not limited to a beep, an indicator light, a check mark on the display, or a text statement on the display. The software may be configured to display an index of scanned cards that has a rolodex-like appearance, that allows users to browse forward or backward, and that provides search features on all card fields. The card fields may be suitably categorized. The software may be configured to allow the user to navigate through menus by selecting an indicator or alert or by selecting action buttons. The software may be configured to create multi-level categorizations. Thus, for example, without limitation, the software may be adapted to categorize a business card by a field such as, but not limited to, industry, client, or prospect. The software may also permit groupings of cards, for example, without limitation; the card may be associated with a particular business conference where it was collected. The software may be configured to secure selected cards on the device. For example, without limitation, viewing of the cards, or of certain designated cards, may be password protected. The software may be configured to allow drill-through on business cards. For example, without limitation, the software may be configured to allow the user to select a field on a business card and to retrieve other cards from memory that are in the same company or industry. A software application may optionally be configured to allow any of the foregoing devices and any other electronic devices to be controlled by a secondary device such as, without limitation, a remote. The software might, in some embodiments, display a control form that details controlling features of the device. The remote may optionally be configured to control devices on the fly through use of an expert system and the like. It is contemplated that a similar application may be readily configured to allow laptops, mp3 players, PDA, cellular phones, external devices, desktops, etc to be controlled by the same remote. It is further contemplated that any suitable device that is used with the main computing device may be controlled. Those skilled in the art will recognize a multiplicity of suitable remote designs and product implementations.

In some embodiments the software may be configured to allow the user to create associations or links between cards for example, without limitation, the software may be configured to allow the user to associate the cards of contacts that were met at the same time. The software may be configured to allow the user to load extra notes into the device from desktop software for example, without limitation, sales data. The software may be configured to allow the user to make use of additional features and data, such as, but not limited to, corporate data stored on the device, clippings from corporate databases such as, but not limited to, lists of customers, lists of prospects, products in use at the corporate offices, and other features. The device may also be configured to retrieve this information from an internal database on the device and to display it to the user promptly so that user knows whether or not the prospect is a customer in Georgia, for instance, without limitation. The software may be configured to allow the user to select which cards to synchronize with desktop or corporate databases. The software may be configured to allow top contacts to appear on a menu for quick reference or to display the list of top contacts when the device is turned on.

In some embodiments the device can be configured to communicate, in a one-way or two-way fashion, with a device such as, but not limited to, a cell phone, laptop, PDA, or other portable communications device. For example, without limitation, a sales representative can use the device to acknowledge a note from a secretary that a call was made into an account, along with a request to return the call. The sales representative can then acknowledge receipt of the message with a note such as, but not limited to, a checkmark, circle, line, or other indicia on the message, and/or can make the call and then use such an indicia to note that the task was completed. The marking feature may be initiated by pressing a button on the device or on a stylus or pen configured to be used with the device. Also, the device may be configured to permit the indicia to be placed anywhere within the display area. In some embodiments, user notes and other pertinent information can be made available promptly, as through two-way synchronization of the device with cell phone and PDAs. In some embodiments, the device may be configured to communicate with a cell phone or PDA and to allow the telephone number to be displayed and dialed on the cell phone. The device may also be configured to communicate with a desktop computer, and may be further configured to fax items using fax numbers stored on the device. The device may include a cell phone or similar communications functionalities. Voice over UP technology may be added to a device when wireless technologies are available allowing information and audio notes to be delivered via Voice Over IP or other network protocols.

The device may be provided with a stylus or pen. In some embodiments, the stylus or pen may be utilized to write on the device. The device may be provided with a calculator. In some embodiments, the device may be equipped with desktop software. In such embodiments, the user's contact information, address book, and other such information may be loaded directly into contact database solutions from third party vendors such as, but not limited to, ACT! or Goldmine. The device may be configured to store receipts for expense reporting, or may be adapted to scan in receipts. The device may be provided with applications to collect information such as business expense receipts. The device may be configured to scan in user notes on various media, such as, but not limited to, notes created on paper, notes provided with a repositionable adhesive, etc. In some embodiments, the software may be equipped with suitable programming to allow it to implement an action plan. For example, without limitation, when a user meets a contact and scans the contact's business card into the device, the software may execute an action plan at the time of scanning or later during desktop/laptop synchronization. This action plan may include, without limitation, such common follow-up tasks as sending the contact an email or a product or firm brochure, or following up with the contact after a specified period of time, for example, without limitation, in a week. The action plan may be sent to a secretary, an assistant, or other person to execute.

In some embodiments, the device may be configured to allow extensive planning activities and tasks to be made available on the device. These include advanced Customer Relationship Management Solutions (CRM).functionalities such as “deal analytics”. “Deal analytics” include, without limitation, a software solution for analyzing sales deals. Prospect and customer data can be downloaded to the device from a corporate software package.

In some embodiments, the software and/or hardware of the device may be configured to allow documents to be displayed in a normal view or in a landscape view on the display. The device may be provided with accessories such as, but not limited to, a digital keyboard, a built-in headset, an engraved placeholder, digital function buttons, a time-sensitive inner cooling fan, a receiver for TV/radio, on-board audio/video help functions, and other such features. Any of these features can be made available on other mobile and desktop devices. The device may be provided with a button, latch or other mechanism that provides the user access to the scanning region for cleaning or maintenance purposes, or to remove jammed documents. The device may also be provided with an eject mechanism or functionality which operates to deny access to the scanning region or to the document feeding mechanism of the scanner when a document jam has been detected, or which operates to eject any documents in the document feeder or scanning mechanism under these conditions. The device may also be equipped with suitable alarm or notification system to notify the user of the existence of a document jam. This notification system may include, for example without limitation, an audio, textual, graphical and/or color-coded alert, which identifies the location of the problem within the device.

In some embodiments, the scanning device may be provided with a top portion that is engaged to the bottom portion of the device by sliding. The top portion may be adapted to slide in a horizontal and/or vertical direction. In one particular embodiment, the bottom portion of the device contains a display and the top portion contains a scanning device in another embodiment the top portion is a display the, and the bottom portion is a scanning device. And in yet another embodiment, there is no display. A document to be scanned may be inserted into the top or through the side of the device. This device may have any or all of the various features described herein with respect to other embodiments of the device.

In some embodiments, the device may have a clear covering which may comprise plastic, glass, clear technologies, or other suitably transparent materials. The device is configured such that, when a card or other document is inserted into the device, it can be viewed through the transparent cover. The user can also see the document as it is scanned and as it exits the device. The cover may also serve as an actual display interface where digitized images may be viewed, or the display interface may sit below the transparent cover. The transparent cover may be opened to release the card. It is contemplated that the use of clear technologies may be implemented on any type of suitable device, including, without limitation, electronic, computing devices, and medical equipment.

The device may be configured to permit image adjustments, such as size or color adjustments, to be made before or after a document is scanned. The device may have one or more, preferably low-level, light sources built into it to facilitate handling or usage of the device in a darkened setting. These light sources may include, for example, without limitation, one or more LEDs. In some embodiments the device may be implemented as an open, one-sided device. This embodiment comprises an open display area with optional pockets on the back to store printed business cards. In this embodiment the display area remains open at all times.

In some embodiments, the devices described herein may be equipped with one or more displays that open up along an axis to release a card or other document that has been inserted into the device, or to allow such a document to be inserted into the device. Alternatively, the device may be equipped with a surface that opens up along an axis for the aforementioned purposes, and in which the axis divides the surface into a first portion that serves as a viewing area, and a second portion, which serves as a scanning area.

FIG. 11 illustrates exemplary digitizers with multiple displays, in accordance with an embodiment of the present invention. The device may have two or more displays for example, without limitation; displays appear on the left and right side when opened. This allows the device to run parallel applications, or one application that uses both displays simultaneously to combine into a single display when a larger display area is required. A device 1100 shows two displays running parallel applications, and a device 1101 shows two displays running simultaneously. The displays preferably are able to communicate with one another. Thus, in one embodiment, each side is a mini-sized PDA-like device, which can operate independently or as codependents. The device may be used as a true Mobile ElS device that fits in your pocket for example, without limitation, pocketElS, pocketgolf, pocketBible.

In some embodiments where the device has two or more displays, the device may be configured so that it can be pulled apart into two independent devices, each equipped with a display that can communicate with each other. In other embodiments the device may be adapted so that one side can be quickly converted into a keyboard. This may be accomplished with either a digital keyboard or by a flip method (one side of display flips into a keyboard with embedded keys). In some embodiments, when a display sits on the exterior of a device embodiment that opens and closes like a book, the display on the exterior, can, optionally, flip over when the device is in an open position. When the display flips over, the device has a display on the left side and a scanning region (or joint display) on the right side. Moreover, the display may be configured to flip over and back by pushing against the display or by pressing a button on the device, or any number of other suitable ways.

In some embodiments where the device has two or more displays or discrete scanning and display areas, the device may be fashioned in book format, so that the user can literally turn the page (display) and another page (display) appears, or so that a display area is disposed on one page, and a scanning area is disposed on another page. This may be accomplished, for example, without limitation, by equipping the device with back-to-back displays. Similarly, in some embodiments, the device may be provided with a book-like enclosure that encases the scanning device and the display. In such embodiments, a flap may be provided to hold business cards on a portion of the case, for example, without limitation, the left side. The flap preferably comprises leather, but may be any resilient material such as, but not limited to, plastic, heavy fabric, metal, granite, marble, or a clear glass-like material, etc. These embodiments may also be constructed so that the device has the appearance of a book when the case is closed. For example, without limitation, the enclosure may be provided with inner edges that are gold-covered. In some embodiments, the book format may be utilized to effect two-sided scanning. A similar result may be achieved by creating the devices so that they are stackable in a way that disposes a scanning region on each side of the document.

In some embodiments, the device may be provided with device management software solutions that allow for management of the device or of other devices. The software may operate to accomplish functions such as, but not limited to, monitoring the operation of the unit, examining the accuracy of readings, checking synchronization operations, and updating the device, or other devices, with required software. The device may be optionally adapted to provide visualization of the device location (remote monitoring may not be needed). In some embodiments, the device is configured to also emit a signal that a centralized database can capture to locate and manage the device.

The device may be adapted to synchronize contacts, notes, and audio notes into a central database on a corporate network, or to merge with an existing Customer Relationship Management Solutions (CRM) or contact management solution on a corporate network. The device may be provided with enterprise software that integrates with third party synchronization tools such as, but not limited to, Intellisync or similar software, and may utilize common synchronization methods. The device may be adapted to be sync-compatible with a variety of synchronization software programs.

In some embodiments the device may be provided with contact management software. The device may be adapted to coordinate contact information between offices and locations. The device may be further adapted to recognize if a contact is a customer or a prospect, and to identify which sales representative is responsible for a particular company or industry area. The device may be configured to send alerts to staff members in a corporation who may need contact information that has been collected. For example, without limitation, a note may be attached to a company, which causes an alert to be sent to a particular representative any time new contact information is collected that references a particular customer or potential customer. The device may be integrated with contact software, so that additional tools and data may be off-loaded to the contact software from a third party vendor. The device may be adapted to organize contacts by different fields such as, but not limited to, industry, company, managing region, etc. The device may be adapted to track contacts loaded by employee and department.

The device may be adapted to allow the device to be registered, and to denote the time/date and any other needed details. The device may be adapted to retrieve news and publicly available data into a database promptly on every contact. The device may be adapted to allow users to add categories to be downloaded to the device, to allow additional notes to be added on the contact and downloaded to the device, or the device may be registered in a corporate database with needed details such as the location of the device, time, date, and usage information. The device may be adapted to allow the user to select which cards to keep on the device. For example, without limitation, the user may be interested in keeping only business contacts on the device, or in keeping only the top ten contacts.

The device may be adapted to allow the user to manage information stored on the device with information stored on the network. For example, without limitation, as the sales person prepares to leave for Florida for a sales meeting, she can connect to the network and begin to manage the meeting the client or prospect by downloading any information that proves useful for a successful encounter. This approach is advantageous in that it provides for consistency. The device may be adapted to manage software and hardware inventory and device backup.

The device may be provided with software that enables the device to utilize an email client as a vehicle to disseminate forms across a network. This software may be present, for example without limitation, as an additional software layer over the email client. In one particular application, this software may be used to create spreadsheet templates inside of the email client, which may then be used to disseminate contact information and other such data to other users of the device and to corporate databases. Hence, this software allows the user to leverage existing, widely disseminated software, such as, but not limited to, the Microsoft OUTLOOK® email platform, for the dissemination of forms and data across a network. In some embodiments, the forms that come across in an email message are interactive Such that a user can input data, annotate the message with additional notes, add images, answer questions, pose questions, add color, add indicators, add computations, add spreadsheets, and add many other types of functions. These types of messages are organized in the email database such that continuous communication can occur between parties. The software tracks messages between parties based on subject matter. Those skilled in the art will readily recognize that this software may be designed in multiplicity of suitable and alternative way in light of the present teaching. It is contemplated that many types of standard business intelligence technologies may be properly used.

In various alternate implementations, the embodiments of the device described herein may have these additional uses. The device may be provided with a viewer for product demonstrations. For example, without limitation, information may be stored on the device digitally, or may use a card insert such as, but not limited to, a plastic credit card like or paper insert to display product information with color and audio features. In some embodiments, the device may be provided with GPS, which may operate digitally or with a card insert as described previously. The GPS card may be limited to a particular city or state. The GPS data may exist locally on the device, for example, without limitation, via software installation, may be viewable, and may be retrievable remotely. The device may be adapted to read a business card with product information embedded or encoded on the card. The device may be adapted to read music either in printed musical scales or in a digital encoded format and play it back. The device may also be configured to display a musical instrument, and to allow the user to play the instrument and/or to create musical compositions. Some embodiments of the present device are provided with a software viewer for product demonstrations and to present product brochures to prospects and customers. This type of information can be found on a business card or a business-sized card (plastic or otherwise). The business card can, for example, have product information on the back of the card, embedded in a logo, or embedded in a bar code. For example, without limitation, the information may also be found on a card (paper, plastic, or otherwise) designed specifically for this purpose. By way of further example, without limitation, information can be stored on the device digitally, or a business card insert can be used such as, but not limited to, a plastic credit card like or paper card like insert that has interactive product information (e.g., with color and audio features) on it.

The following are some non-limiting examples of particular device implementations.

The device may be implemented as a traditional business card scanner. In this implementation, the device is adapted to attach to a desktop computer or laptop via a cable or by wireless means. The device accepts business card, scans the text on the card, and makes the data available on the connecting device through business card software, contact software, or a database. Some embodiments of the business card scanner may comprise a display, computing device, and an advanced software functionality.

In some embodiments the device may be a single-sided unit. In this embodiment, the user places a document face down on a flat surface and presses a button to scan the document. This type of scanner can be any number of shapes or sizes, but it is most likely a desktop scanner and may or may not have a display. The present embodiment can be used for other purposes such as, but not limited to, computation, analysis, Internet browsing, etc. This device interacts with or without a second device that provides a service to a connecting device.

Some embodiments may be implemented as an Ethernet/PCMCIA device. In this embodiment, the device is a business card scanner that is shaped like an Ethernet card and can fit into the PCMCIA slot available on most laptop devices. The device slides into the PCMCIA slot and the user can insert a business card into the device to image or scan the business card. In this embodiment, the scanning method may be as simple as a camera lens or a more sophisticated imaging device such as, but not limited to, the linear scanner or flatbed scanner described previously in FIG. 2 through FIG. 5 and FIG. 9, respectively. In some embodiments the Ethernet scanning device may be built into the laptop.

In another embodiment, the device may be implemented into a regular computing device's display. This embodiment allows documents of any size to be swiped into the computing device by moving the document over the display of the computing device. In alternative embodiments, a pop-up component or a slot scanner may be placed somewhere on the frame of the display to enable a document to be inserted and scanned.

In some applications the device may act as a business card album. In this implementation, the device is in the form of an album-like folder that holds multiple business cards. In this implementation, cards are placed in a business card sized flap inside of the album by the user. The ordering of the cards is typically not important. The device typically holds at least twenty-five cards and, in some embodiments, may be adapted to hold hundreds of cards.

In some embodiments the device may act as a mobile business card scanner. In this implementation, the device is fashioned as a carry-along scanning solution for prompt scanning. In other implementations, the user may interact with business cards, may categorize contacts, and can enter contact notes.

Many of the embodiments described herein may also be implemented as a useful everyday business tool. In this implementation, the device is useful for more than business card collection. The device may be provided with software that includes other small applications for functions such as, but not limited to, contacts, meetings, audio notes, wireless communications for enterprise solutions, etc. The device may have the ability to scan product information such as, but not limited to, product cards, information about products being sold, information about the user's corporation, or information about the prospect's corporation. The device may also be adapted to retrieve news clippings.

The device can also be used, or adapted for use as equipment such as, but not limited to, a cellular phone, pager or other wireless device, a recording device, a camera device or video recorder, a device to play audio files such as, but not limited to, mp3 files, digitized music, or music encoded on business-sized cards, a medium for television or a calculator and financial tool.

In some implementations, the device may be configured as an enhanced desktop business card scanning device. In this implementation the scanning region opens or lifts when a button is pressed, the document is placed on the scanning region, the scanning region closes, and scanning occurs. Some embodiments may include, without limitation, a display interface that may be positioned on the device in a variety of locations such as, but not limited to, the top, the back, or side of the device.

In some embodiments the device may be implemented as a two-level business card scanner. This implementation has a different look and feel for desktop business card scanners, such as, but not limited to, a stacked, layered, or two-level device. For example without limitation, scanning occurs at the top of the device, and business cards drop into a compartment at the bottom of the device.

In some implementations, the device has the ability to load multiple cards, one after another.

In some embodiments, the device may be implemented as a mobile and desktop business card scanner combined. In this implementation, the mobile device may be used with or without the desktop version. For example, without limitation, the device may be adapted such that the user can pull the mobile device off of desktop version and go to a networking event.

In some embodiments the device may be implemented as a desktop business card scanner with a display. In this implementation, the device may be provided with a display on a desktop scanning device for browsing.

In some embodiments the device can scan two or more documents at once by providing multiple scanning mechanisms such as, but not limited to, feeder slots, camera lenses, or flatbed scanners.

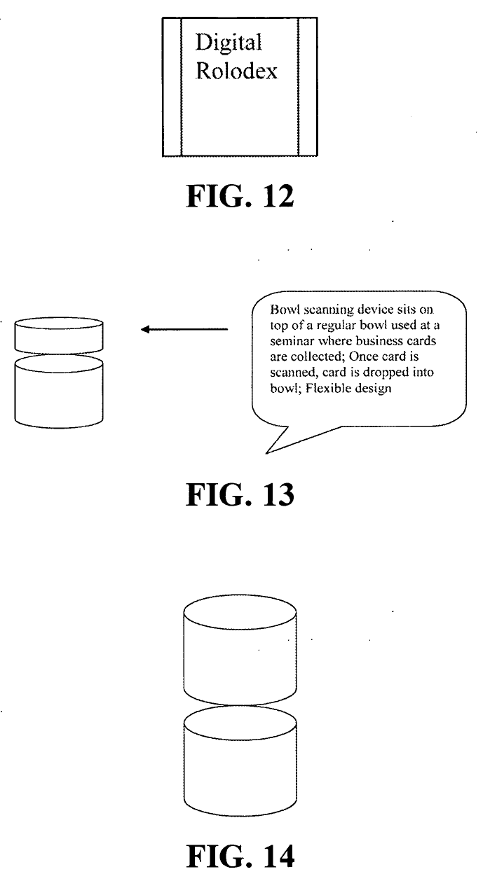

FIG. 12 illustrates an exemplary digital Rolodex, in accordance with an embodiment of the present invention. In this embodiment, the device may be fashioned as a true digital Rolodex and as desktop tool with or without scanning feature and may have a display for browsing. Some embodiments may be designed with a display and a know so that contacts can be scrolled through, similar to a paper Rolodex. This embodiment may also include features such as, but not limited to, compartments and note taking capabilities. In some alternative embodiments, the digital rolodex may optionally have processing and computing resources built into the device itself.

In some embodiments the device may be implemented as a business card holder on a scanning device. In this implementation, the device is designed with a Rolodex look and feel, for example, without limitation, it may be provided with a wooded compartment attached to desktop scanner. In some embodiments, the device may be adapted to scan a business card and then place the card into the next available slot in a cardholder, without alphabetization. An image of the card is also stored in digital form. The device is adapted to permit the user to retrieve either the digital image of the card, or the card itself.

In some embodiments the device may be implemented as a business card holder for printed cards. In this implementation, the device is fashioned as an automated approach to storing business cards. For example, without limitation, the device may be provided with a slot into which a business card can be inserted, and can be adapted to alphabetize cards automatically. The device may also be provided with a display. In some embodiments, the device may hold 250-500 business cards. Preferably, the electrical component is separate from the storage component. For example, without limitation, the storage component may be designed such that the storage compartment with collected business cards can be removed and a new storage compartment can be attached to the device.

FIG. 13 and FIG. 14 illustrate exemplary bowl scanning devices, in accordance with embodiments of the present invention. In this embodiment, the device may be adapted to sit on top of a bowl, which may be placed on a table for example, without limitation, at an event or trade show. Then, instead of dropping cards into the bowl, the cards are inserted into a slot in the device and are scanned. After scanning, the card is dropped into the bowl, and the host has a digital set of business cards that are promptly available. The scanner portion may be detached form the bowl and used separately.

In some embodiments the device may be implemented as a business card slot on traditional scanners, copiers, or printers. In this implementation, the device is provided as an accessory that can quickly scan hundreds of cards.

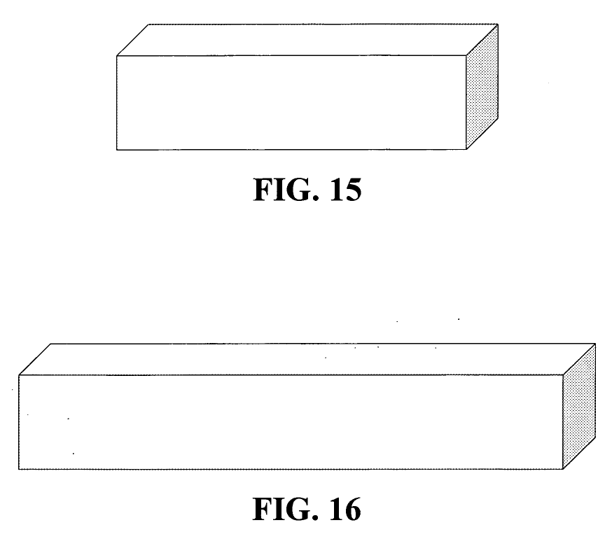

FIG. 15 and FIG. 16 illustrate exemplary business card storage boxes, in accordance with an embodiment of the present invention. FIG. 16 illustrates an exemplary business card storage box that is equipped with an automatic alphabetizer, in accordance with an embodiment of the present invention. In this embodiment, the device is provided with storage boxes, compartments, or other such accessories to hold business cards, typically arranged in alphabetical order, for example, without limitation, similar to a rolodex-style offering. The storage box may have sections for the various letters of the alphabets. The consumer places a business card in the proper section by means such as, but not limited to, a staple, insert slot, or hole-punch. The present embodiment has no scanning abilities but comprises plastic dividers to aid in sorting and organizing of business cards. In some alternative embodiments, devices with any of these features are configured to have scanning technology detached or attached. Technology enabling automatic and systematic alphabetization of any size documents can be designed according to a multiplicity of known techniques. It is contemplated that these techniques can, in some embodiments, be used with file cabinets, folders, and large documents. By way of example, and not limitation, these folders and documents can be marked with embedded codes or items such as RFID. In this way, the documents can then be alphabetized or located easily.

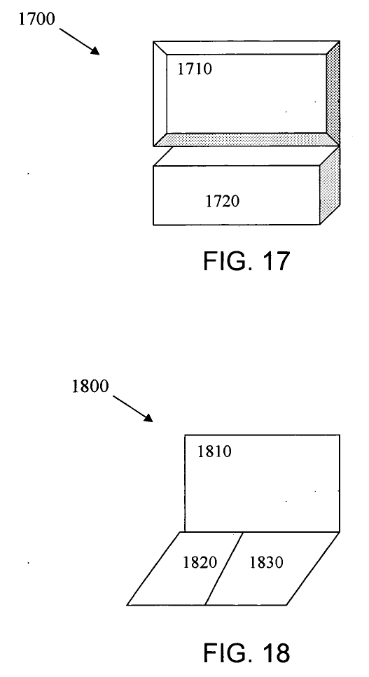

FIG. 17 illustrates an exemplary digitizer device 1700, in accordance with an alternative embodiment of the present invention, wherein the scanner, 1720 is located at the bottom of the device 1700 where computing resources are typically located. Display 1710 is located at the top of the scanning unit located below. Display 1710 is often useful for viewing and for making adjustments to the documents being scanned. In alternative embodiments the device can also be equipped with computing resources including, but not limited to, microprocessor, memory, storage space, and a slot for external media. Depending upon the needs of the particular application, those skilled in the art will readily recognize how to configure the scanner to scan potentially unlimited range of documents sizes. The display sized as needed and, in some embodiments, can also optionally be folded down when not in use. The document can be inserted into the scanning component any number of ways using, for example, without limitation, any of the methods taught by the present invention. With some scanners (any size), labels or other markings can be placed on the digital or the paper document. For instance, without limitation, there are a number of legal processes that require labels to be taped onto documents, and in some instances, the documents are labeled digitally with subject matter text, client information, etc.

FIG. 18 illustrates an exemplary digitizer device 1800, in accordance with another embodiment of the present invention. In the example shown, a full display 1810 is located at the top of the device and a scanning device 1820 is located at the bottom left, and a writing area 1830 is located on the bottom right side. Other embodiments may locate these components in alternative positions depending upon the needs of the particular application. Digitizer device 1800 closes like a book, and can be made into any suitable of size. This design provides the user with more writing room, and combines the features of a PDA with scanning and writing. The bottom half can also be configured as a full writing area with scanning technology. In alternative embodiments, scanning device 1820 and writing area 1830 may be combined to provide a larger or dual scanning region, or a larger writing area, or a larger second display. It is contemplated that many other technologies may be added to this unit including, but not limited to, storage media and components, audio and sound, speakers and microphones, etc.

Any of the foregoing device embodiments units may be configured with a cellular capability according to conventional techniques.

In some implementations the device may be a book page scanner/printer that attaches to a traditional copier or scanner. In this implementation, the device is placed in between pages of a book, where it can scan, copy, and print portions of the book. The device may operate manually, whereby the user places the device between two pages, presses a button, and one or both pages are scanned, or the device may operate automatically, whereby the device is placed at a certain position within the book and designated pages are scanned. It is contemplated that there are a multiplicity of alternate and suitable designs for this type of device. For example, in one alternative embodiment of the present invention, a larger scanner is designed so that it sits on a table top, in an open position, where the open position of the scanner is at the top. Paper can be loaded into the scanner from the top, or through an automated method.

In some embodiments the device may be implemented as a display with a page positioner on a traditional scanner/copier/printer. In this implementation, the device can view a page and make adjustments on a display before scanning, printing or copying. The present device may be implemented with or as a display, wherein the device views each page, adjustments to the image can be made on a display before scanning, printing, or copying. This approach may be likewise applied to large-size scanners.

In some embodiments the device may be implemented as a mini-sized printer for small documents. In this implementation, the device is a small device that is able to print business cards and other small documents. The following are some non-limiting examples and features of this implementation. The device may be a small device for printing prescriptions or a small device that prints business cards. The device may transform into a true Mobile advanced application device. The device may have a strong processor and memory chip (one display).

The device may be adapted to be used at sporting events by athletes and by attendees. For example, without limitation, the device may be configured to allow golf courses to be displayed on the device. The device may also be configured to allow the user to gamble directly on the device for example, without limitation, by placing bets, or to place food orders.

The device may be provided with true analytics, such as, but not limited to, business and medical applications. The device may be configured as a mobile OLAP, with true relational and multi-dimensional reporting applications.

The device may be deployed as a network of intercommunicating devices at a conference, thus allowing a corporation at the conference to exchange information quickly about contacts similar to, a mini-network. The device may be provided with various case materials, such as, but not limited to, plastic or metal, and may have a marble-like or granite-like appearance. The device may be adapted to wear around the neck. Such embodiments may be particularly useful for users such as, but not limited to, firefighters, field operators walking through an oil field, etc.

In some embodiments the device may be configured as a traditional cellular phone with a display at the top and a keypad at the bottom. In such embodiments, the display may be detachable and capable of functioning as a stand-alone display or writing pad. In some embodiments the device may be implemented as a home or business telephone. In these embodiments the telephone comprises a scanning region and a display. In some telephone embodiments the scanning region and display may pop-up out of the telephone when in use so that they may retract when not in use. In the present embodiment, the telephone comprises a hard drive and connections to a network and can serve as a computing device. The display may be touch or writing enabled. Also, advanced applications can be made available such as, but not limited to, CRM, databases, music, and advanced voice mail features. In other embodiments, notes written on the display or information retrieved on the device can be shared with others in an office or at home.

In some embodiments the device may be usable with plastic business cards, so that the user can scan a plastic card instead of a printed card. The device may be adapted to scan in drivers licenses, and thus may be deployed across a municipal body such as, but not limited to a police force. The device may be configured for inventory purposes in retail settings, where it may be used by sales personnel in a retail store. In such embodiments, the device may be used to check information such as, but not limited to, inventory, product information, contact, prices, etc. The device may be configured as a credit card device, where it may allow independent sales representatives to scan in a credit card, process card information, and receive payment promptly. In some applications, the device can be used to read or scan different types of cards simultaneously (some combination of credit cards, plastic cards, paper business cards, drivers license, etc). The device of the present embodiment can be toggled to read either type by buttons on the device.

The device may be configured as an prompt analyzer of data on a card. Such embodiments are particularly useful in medical and field applications. The device may be configured as a device for students. For example, without limitation, the device can be used for applications such as, but not limited to, reading books, math, reviewing legal definitions, practicing before a test, and storing contact information for classmates. The device may also be configured to allow the user to mark up text with a stylus or pen. Annotations can be made on any type of file, and either associated with the file or stored in an annotation database.

The device may be configured as a gaming or educational device for children. The device may be configured as a device for the elderly, where it can be used to store information such as, but not limited to, health information, contact information, social security information, etc., and may be used to scan in physician data.

The device may be configured as a device for stockbrokers. The device may be configured as a device for law enforcement officers. For example, without limitation, it may be used as a digital badge. The device may be configured as a writing device, in which case one or multiple displays can be turned into a writing area. In such embodiments, the user can use a tool such as, but not limited to, a stylus, pen, touch screen, etc. to enter or manipulate data, or to take quick notes. The device may be configured as an alternative writing device, in which the stylus size adjusts to fit onto the device. The device of the present embodiments can be used with a computing device as a writing pad or an auxiliary viewing device via USB, wireless, or some other method. The device can attach to a keyboard, the display, the computing device's CPU, or other computer components.

In some embodiments, the device may be equipped with various mice or pointing devices. The device may be controllable by a separate device, such as, but not limited to, a pointer, a mouse, or a remote control. The device may be adapted for wireless connection to a projector. In such embodiments, the device may be used to control the projector, or to display slides from a presentation on the device. The device may be provided with a means for placing a corporate name on the outside of the device.

In some embodiments the device may be implemented as a redesigned desktop scanner. In this implementation, the device may have the following features and capabilities. The device may have an improved professional design, for example without limitation; the exterior look and feel may be different than traditional scanners. The device may have a two-layered design. The device may have a storage compartment for holding printed business cards. The device may have a display. There may be a memory processor on the circuit board of the device for storing information in the device. The device may connect to other devices via a USB or wireless connection. The device may utilize a multi-loader feature and be able to load and stack cards for scanning purposes. The device may have a design such as, but not limited to a box design, tube/cylinder design, or a two-box stacked design. A mobile business card scanner can optionally connect to this device. The device may have any number of levels for scanning and sorting the business cards. For instance, without limitation, the device may be designed to have a scanner sitting on a top level with a tray or compartment sitting on the bottom level to hold the business cards.

Any of the foregoing embodiments described may have any, all or none of the following features. Any embodiment may have the circuitry necessary to give the device similar capabilities to a PDA and can use any number of scanning methods such as, but not limited to, the feeder method, clamshell, imaging, etc. Any of the implementations described herein can have a display and can be used with a variety of electronic mobile devices including, but not limited to, cellular phones, PDAs or laptops. Any of the embodiments that have a case may have a lock on the outside of the case if desired. Any of the implementations described herein that open and close may have a mechanism to hold the device in a closed position when not in use such as, but not limited to, a latch, a button, or a push open. Any of the foregoing embodiments may be configured to include any of the following: an antenna; a computing device with processors and memory; pockets to hold printed cards; one or more displays; a display that hides the scanning region; and the display can optionally extend over a larger area than the scanning region; any of the scanning regions can be optionally sealed off; a writing area, that can be optionally combined with scanning and a display area; a stylus, pen, or pointing device; camera technology and music technology such as, without limitation, mp3 technology.

Calculator software can have a web interface and have multiple dimensions, including a knowledge management database, annotations, and a set of formulas, that can be used. Multi-dimensional techniques can be used to hold any type of data including product designs and frameworks.

It is contemplated that the foregoing embodiments of the present invention may combine any number of technologies on the same device such as, without limitation, writing, scanning, viewing, television viewing, etc. Electronic circuit boards can be properly designed for these devices according to known techniques. For instance, without limitation, the device may have any number of circuit boards and/or computational means and/or software to provide the needed technology or functionality.

Alternate embodiments of the present invention may be optionally configured with what is referred to as a “health card”, which can be used to store patient information, insurance information, and other private and personal data. This card can be given to the medical provider to gain access to any of this data. In return, the medical provider updates the card with information for that day's visit. These types of cards can be used with these types of devices. This software and card can be designed according to conventional techniques. The card can also be used to track common health related matters, including, but not limited to, annual deductibles, patient payments, and insurance payments. Moreover, diagnostic images can be stored on the device, and properly analyzed using advanced analysis, the results of which can optionally be stored on the image itself. Those skilled in the art, in light of the present teachings will possess the know-how to properly implement the health card capability depending upon the needs of the particular application.

Other embodiments of the present invention may be optionally configured with what is referred to as a “receipt card” to display information on purchases made. In one implementation, a receipt card is a credit card sized and like plastic or paper card that captures consumer purchases. Those skilled in the art, in light of the present teachings will possess the know-how to properly implement the receipt card capability depending upon the needs of the particular application.

Yet other embodiments of the present invention may be optionally configured with software enabling digital check book features. Those skilled in the art, in light of the present teachings will possess the know-how to properly implement this capability depending upon the needs of the particular application.

Still other embodiments of the present invention may be optionally configured with advanced medical technology incorporated into the device such as, without limitation, diabetic testing and analysis software or cardiovascular testing with or without a secondary device. Those skilled in the art, in light of the present teachings will possess the know-how to properly implement this capability depending upon the needs of the particular application. Depending upon the needs of the particular application, any of these devices can be designed such that the technology (e.,g., scanning, printing, etc . . . ) and the computing components operate independently using one or more processors, one or more memory sticks, and circuitry within the same unit.

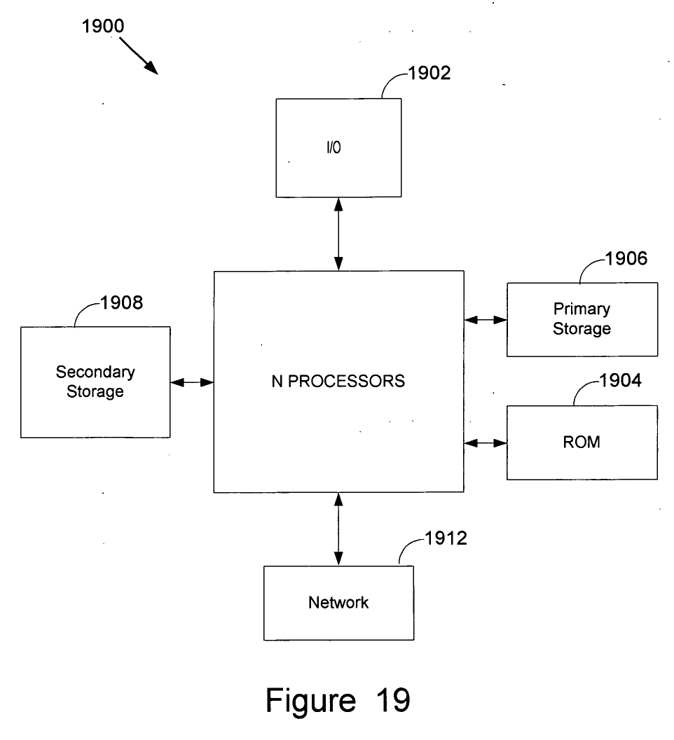

FIG. 19 illustrates a typical computer system that, when appropriately configured or designed, can serve as a computer system in which the invention may be embodied. The computer system 1900 includes any number of processors 1902 (also referred to as central processing units, or CPUs) that are coupled to storage devices including primary storage 1906 (typically a random access memory, or RAM), primary storage 1904 (typically a read only memory, or ROM). CPU 1902 may be of various types including microcontrollers and microprocessors such as programmable devices (e.g., CPLDs and FPGAs) and unprogrammable devices such as gate array ASICs or general purpose microprocessors. As is well known in the art, primary storage 1904 acts to transfer data and instructions uni-directionally to the CPU and primary storage 1906 is used typically to transfer data and instructions in a bi-directional manner. Both of these primary storage devices may include any suitable computer-readable media such as those described above. A mass storage device 1908 may also be coupled bi-directionally to CPU 1902 and provides additional data storage capacity and may include any of the computer-readable media described above. Mass storage device 1908 may be used to store programs, data and the like and is typically a secondary storage medium such as a hard disk. It will be appreciated that the information retained within the mass storage device 1908, may, in appropriate cases, be incorporated in standard fashion as part of primary storage 1906 as virtual memory. A specific mass storage device such as a CD-ROM 1914 may also pass data uni-directionally to the CPU.

CPU 1902 may also be coupled to an interface 1910 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1902 optionally may be coupled to an external device such as a database or a computer or telecommunications or internet network using an external connection as shown generally at 1912. With such a connection, it is contemplated that the CPU might receive information from the network, or might output information to the network in the course of performing the method steps described in the teachings of the present invention.

Having fully described at least one embodiment of the present invention, other equivalent or alternative methods of implementing a portable document digitizer, according to the present invention, will be apparent to those skilled in the art. The invention has been described above by way of illustration, and the specific embodiments disclosed are not intended to limit the invention to the particular forms or components disclosed therein. The invention is thus to cover all modifications, equivalents, and alternatives falling within the spirit and scope of the following claims.

What is claimed is:

1. A hand-held image digitizer, comprising:
a chassis having first and second components; and
a scanner disposed within said chassis, said scanner being adapted to digitize the image of a surface of a document placed within a scanning region inside of said chassis, said chassis being configured to be movable from a first configuration in which said scanning region is sealed off to a second configuration in which said scanning region is open to receive a document.

2. The image digitizer of claim 1, in which said first component is movable relative to said second component.

3. The image digitizer of claim 2, in which said first component of said chassis is configured with an aperture, wherein said aperture is in open communication with said scanning region when the image digitizer is in the second configuration, and wherein said aperture is in closed communication with said scanning region when the image digitizer is in the second configuration.

4. The image digitizer of claim 2, in which said second component is spring-activated, and wherein said image digitizer is adapted to move from said first configuration to said second configuration upon the application of pressure on said second component.

5. The image digitizer of claim 2, in which said first and second components are connected by a hinge.

6. The image digitizer of claim 5, in which said hinge connects said second component to said first component along the major axis of the second component.

7. The image digitizer of claim 2, in which said image digitizer has a clamshell design.

8. The image digitizer of claim 1, in which said scanning region is adapted to scan a document no larger than about 4 inches long and about 3 inches wide.

9. The image digitizer of claim 1, in which said image digitizer is larger than a conventional business card scanner.

10. The image digitizer of claim 1, in which said image digitizer is about the size of a conventional travel binder that holds airline tickets.

11. The image digitizer of claim 1, further comprising at least one display suitable for displaying a graphical user interface to said image digitizer and/or a version of the digitized image scanned by said scanning means.

12. The image digitizer of claim 11, in which at least one said display is a touch sensitive display configured to receive touch input from a finger or a writing instrument suitable for contacting said touch sensitive display properly to input writing thereto.

13. The image digitizer of claim 11, in which said image digitizer comprises at least two displays, and means for combining said at least two displays into a single display to achieve a larger display area.

14. The image digitizer of claim 1, further comprising:
a control panel configured to input user commands; and
a processing unit in electronic communication with said control panel, said processing unit being adapted to receive and process user input commands from the control panel.

15. The image digitizer of claim 11, in which said processing unit is further adapted to control the operation of the scanner.

16. The image digitizer of claim 11, in which the scanner comprises:
a light source disposed adjacent to said scanning region and adapted to provide light for scanning, and
a photoelectronic imaging device disposed adjacent to said scanning region and being adapted to capture the image of a surface of a document disposed in said scanning region.

17. The image digitizer of claim 1, further comprising two or more discrete scanning and/or display areas, said image digitizer being configured with means for them both to cooperate in a book format.

18. The image digitizer of claim 1, further comprising means for enabling said image digitizer to operate as a traditional cellular phone.

19. The image digitizer of claim 1, further comprising means for enabling said image digitizer to scan in a credit card, process card information, and receive payment.

20. The image digitizer of claim 1, further comprising means for enabling said image digitizer to promptly receive and analyze data on a card.

21. The image digitizer of claim 1, further comprising a microphone and optionally a speaker, in which said image digitizer is configured to annotate into stored multimedia content sounds detected from said microphone, and to optionally play back any such sound annotations through said optional speaker.

22. The image digitizer of claim 1, further comprising means for enabling said image digitizer to properly receive and process a card that is swiped over said scanning region.

23. A hand-held image digitizer, comprising:
a housing having a base component and a pop-up component with an aperture therein;
a scanning region inside of said housing; and
a scanner disposed within said housing adjacent to said scanning region, said scanner being adapted to digitize the image of a surface of a document placed within the scanning region;
wherein said pop-up component is movable from a first position in which said scanning region is sealed off from the exterior of said housing, to a second position in which said scanning region is open to receive a document via said aperture.

24. The image digitizer of claim 23, further comprising:
a light source disposed adjacent to said scanning region and adapted to provide light for scanning; and
a photoelectronic imaging device disposed adjacent to said scanning region and being adapted to capture the image of a surface of a document disposed in said scanning region.

25. The image digitizer of claim 23, in which said pop-up component is movable from said first position to said second position by the application of finger pressure to said second component.

26. The image digitizer of claim 23, in which said housing is larger than a conventional business card scanner.

27. The image digitizer of claim 23, in which said image digitizer is about the size of a conventional travel binder that holds airline tickets.

28. The image digitizer of claim 23, further comprising at least one display suitable for displaying a graphical user interface to said image digitizer and/or a version of the digitized image scanned by said scanning means.

29. The image digitizer of claim 28, in which said at least one display is a touch sensitive display configured to receive touch input from a finger or a writing instrument suitable for contacting said touch sensitive display properly to input writing thereto.

30. The image digitizer of claim 28, in which said processing unit is in further electronic communication with a first of said at least one displays and configured to execute a first software application, the graphical user interface for which is displayed on said first of said at least one displays.

31. The image digitizer of claim 30, further comprising a second processing unit, which is in electronic communication with a second of said at least one displays and configured to execute a second software application, the graphical user interface for which is displayed on said second of said at least one displays.

32. The image digitizer of claim 31, in which said first and second display/processing unit are configured as independent operating units which may be physically separated from one another while preserving their operation, and are optional further configured to be able to communicate with one another.

33. A personal digital assistant (PDA), comprising:
a housing having a base and a cover hingedly connected to said base;
a scanning region defined on a surface of said base, and
a scanner disposed within said base adjacent to said scanning region, said scanner being adapted to digitize the image of a surface of a document placed on the scanning region.

34. The PDA of claim 33, in which said PDA is a hand-held device.

35. The PDA of claim 33, in which said housing is larger than a conventional business card scanner.

36. The PDA of claim 33, in which said image digitizer is about the size of a conventional travel binder that holds airline tickets.

37. The PDA of claim 33, said PDA further comprising:
a control panel adapted to input user commands; and
a processing unit in electronic communication with said control panel, said processing unit being adapted to receive and process user input commands from the control panel.

38. The PDA of claim 37, in which said control panel is adapted for control of the scanner.

39. A image digitizer, comprising:
scanning means for digitizing the image of a first surface of at least one document placed within a scanning region; and
means for containing, providing access to, and movably supporting said scanning means under normal use thereof.

40. The image digitizer of claim 39, further comprising:
means for inputting user commands or information;
means for receiving and processing user input commands from said inputting means; and
means for controlling the operation of the scanner.

41. The image digitizer of claim 39, further comprising means for feeding said at least one document to be scanning into said scanning means.

42. The image digitizer of claim 39, further comprising scanning means for digitizing the image of a second surface of said at least one document.

43. The image digitizer of claim 39, further comprising scanning means for displaying a graphical user interface to said image digitizer or a version of the digitized image scanned by said scanning means.

44. The image digitizer of claim 43, in which said image digitizer comprises at least two display means, and means for combining said at least two display means into a single display means to achieve a larger display area.

45. The image digitizer of claim 39, further comprising scanning means for temporarily storing said at least one document after it has been scanned by said scanning means.

46. The image digitizer of claim 39, in which said image digitizer is configured with means for achieving a redesigned desktop scanner.

47. The image digitizer of claim 39, further comprising two or more discrete scanning and/or display areas, said image digitizer being configured with means for them both to cooperate in a book format.

48. The image digitizer of claim 39, further comprising means for enabling said image digitizer to operate as a traditional cellular phone.

49. The image digitizer of claim 39, further comprising means for enabling said image digitizer to scan in a credit card, process card information, and receive payment.

50. The image digitizer of claim 39, further comprising means for enabling said image digitizer to promptly receive and analyze data on a card.

51. The image digitizer of claim 39, further comprising a microphone and optionally a speaker, in which said image digitizer is configured to annotate into stored multimedia content sounds detected from said microphone, and to optionally play back any such sound annotations through said optional speaker.

52. The image digitizer of claim 39, further comprising means for enabling said image digitizer to properly receive and process a card that is swiped over said scanning region.
